(19) United States
(12) Patent Application Publication
(10) Pub. No.: US 2026/0156534 A1
(43) Pub. Date: Jun. 4, 2026

(54) PROVISIONING OF A1 POLICY ENHANCEMENT

(71) Applicant: Rakuten Mobile, Inc., Tokyo (JP)

(72) Inventors: Pankaj Tanaji SHETE, Tokyo (JP); Awn MUHAMMAD, Tokyo (JP)

(73) Assignee: Rakuten Mobile, Inc., Tokyo (JP)

(21) Appl. No.: 19/128,598

(22) PCT Filed: Jan. 23, 2025
(86) PCT No.: PCT/US2025/012696

§ 371 Date: May 9, 2025

Related U.S. Application Data
(60) Provisional application No. 63/702,691, filed on Oct. 3, 2024.

(51) Int. Cl. H04W 28/16

(52) U.S. Cl. CPC H04W 28/16

(57) ABSTRACT

Example embodiments of the present disclosure relate to the provisioning of A1 Policy enhancement. According to example embodiments, a system may include a non-real-time (Non-RT) radio access network intelligent controller (RIC). The Non-RT RIC may be configured to generate an A1 policy executable by a near-real-time (Near-RT) RIC and provide the A1 policy to the Near-RT RIC. The A1 policy may include a scope identifier and a policy statement. The policy statement may include a policy type, a policy subtype, a policy objective, a policy resource, and a policy. The policy condition may be associated with at least one of the policy objective and the policy resource.

### CROSS REFERENCE TO RELATED APPLICATION

This application claims priority to U.S. Provisional Patent Application No. 63/702,691 filed with the U.S. Patent and Trademark Office on Oct. 3, 2024, the entire contents of which are incorporated herein by reference.

### TECHNICAL FIELD

The present disclosure relates to the provisioning of enhancement on one or more A1 policies.

### BACKGROUND

The information disclosed in this background section is only for the enhancement of understanding of the general background of the disclosure and should not be taken as an acknowledgement or any form of suggestion that this information forms the prior art already known to a person skilled in the art.

A radio access network (RAN) is an important component in a telecommunications system, as it connects end-user devices (or user equipment) to other parts of the network. The RAN includes a combination of various network elements (NEs) that connect end-users to a core network. Traditionally, the hardware and/or software of a particular RAN is vendor-specific.

Open RAN (O-RAN) technology has emerged to enable multiple vendors to provide hardware and/or software to a telecommunications system. Since different vendors are involved, the type of hardware and/or software provided may also be different. That is, different types of NEs may be provided by different vendors, and depending on the specific service, the NE could be virtualized in software form (e.g., virtual machine (VM)-based, etc.), or could be in physical hardware form (e.g., non-VM based, etc.) Accordingly, O-RAN disaggregates the RAN functions into different entities, such as a central unit (CU), a distributed unit (DU), and a radio unit (RU). Since these entities have open protocols and interfaces between them, they can be developed by different vendors.

The O-RAN components (e.g., CU, DU, etc.) may be controlled by one or more radio access network (RAN) intelligent controllers (RICs), such as a Non-real-time (Non-RT) RIC and near-real-time (Near-RT) RIC. The Non-RT RIC may communicate with the Near-RT RIC via an A1 interface in the O-RAN architecture. In this regard, the Non-RT RIC may provide policy-based management or control to the Near-RT RIC by providing one or more A1 policies thereto, and the Near-RT RIC may execute the A1 policy(s) to further control or manage other O-RAN components.

### SUMMARY

Example embodiments of the present disclosure provide systems, apparatuses, methods, and the like, that effectively and efficiently provisioning A1 policy enhancement.

According to example embodiments, a system may include a Non-RT RIC. The Non-RT RIC may be configured to generate an A1 policy executable by a Near-RT RIC, and then provide the A1 policy to the Near-RT RIC via an A1 interface. The A1 policy may include a scope identifier defining at least one node to which the policy can be applied and a policy statement defining the content of the A1 policy. The policy statement may include a policy type defining a type of the policy, a policy subtype associated with the policy type, a policy objective defining an objective of the policy subtype, a policy resource defining a resource that can be utilized to achieve the policy objective, and a policy condition defining a condition under which the policy statement should be enforced. The policy condition may be associated with at least one of the policy objective and the policy resource.

According to example embodiments, a method may include: generating, by a Non-RT RIC, an A1 policy executable by a Near-RT RIC, and providing, by the Non-RT RIC and via an A1 interface, the A1 policy to the Near-RT RIC. The A1 policy may include a scope identifier defining at least one node to which the policy can be applied and a policy statement defining the content of the A1 policy. The policy statement may include a policy type defining a type of the policy, a policy subtype associated with the policy type, a policy objective defining an objective of the policy subtype, a policy resource defining a resource that can be utilized to achieve the policy objective, and a policy condition defining a condition under which the policy statement should be enforced. The policy condition may be associated with at least one of the policy objective and the policy resource.

According to example embodiments, a non-transitory computer-readable recording medium having recorded thereon instructions executable by a system that includes a non-real-time (Non-RT) radio access network intelligent controller (RIC) to cause the Non-RT RIC to perform a method. The method may include: generating, by a Non-RT RIC, an A1 policy executable by a Near-RT RIC, and providing, by the Non-RT RIC and via an A1 interface, the A1 policy to the Near-RT RIC. The A1 policy may include a scope identifier defining at least one node to which the policy can be applied and a policy statement defining the content of the A1 policy. The policy statement may include a policy type defining a type of the policy, a policy subtype associated with the policy type, a policy objective defining an objective of the policy subtype, a policy resource defining a resource that can be utilized to achieve the policy objective, and a policy condition defining a condition under which the policy statement should be enforced. The policy condition may be associated with at least one of the policy objective and the policy resource.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates an example O-RAN architecture in which one or more example embodiments may be applied;

FIG. 2 illustrates a block diagram of a general policy structure, according to one or more example embodiments;

FIG. 3 illustrates a block diagram of the relationship between a policy statement and a policy condition, according to one or more example embodiments;

FIG. 4, illustrates a block diagram of a first example policy structure, according to one or more example embodiments;

FIG. 5, illustrates a block diagram of a second example policy structure, according to one or more example embodiments;

FIG. 6 illustrates a block diagram of an example method for facilitating the provisioning of A1 policy enhancement, according to one or more example embodiments;

FIG. 7 illustrates a block diagram of an example device for implementing one or more example embodiments; and

FIG. 8 illustrates a block diagram of an example environment for implementing one or more example embodiments.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

Further, although example embodiments of the present disclosure are described herein as being mainly implemented by one or more specific O-RAN components (e.g., Non-RT RIC, etc.), it is contemplated that the example embodiments of the present disclosure may also be implemented by any suitable modules or entities in the O-RAN, without departing from the scope of the present disclosure. For instance, although it is described herein that the Non-RT RIC may be configured to generate and provide an A1 policy to the Near-RT RIC, it can be understood that any other suitable modules or entities in any suitable systems (e.g., O-RAN systems, 3GPP systems, 5G systems, 6G systems, etc.) may be configured to generate or provide the A1 policy to the Near-RT RIC, any other suitable modules or entities in any suitable systems may be configured to receive the A1 policy for utilization, and the like, without departing from the scope of the present disclosure.

It shall be noted that, descriptions of example embodiments of the present disclosure may include terms and names defined in one or more standard organizations, such as the 3rd Generation Partnership Project (3GPP) standard organization, the European Telecommunications Standards Institute (ETSI) standard organization, the Open Radio Access Network (O-RAN) Alliance standard organization, and the like. For instance, the terms “SMO”, “Non-RT RIC”, “Near-RT RIC”, “rApp”, “xApp”, “A1 interface”, “A1 policy”, “scope identifier”, “policy statement”, “E2 interface”, “O1 interface”, “O2 interface”, and the like, as well as the associated features and operations, are to be interpreted as consistent with those specified in one or more technical specifications, unless being described otherwise.

With the evolvement in telecommunication network technologies, the RAN may be disaggregated into multiple nodes or entities. Specifically, in the O-RAN architecture, the RAN functions may be disaggregated into multiple logical nodes or entities, such as a central unit (CU), a distributed unit (DU), and a radio unit (RU). The CU may be a logical node for hosting Radio Resource Control (RRC), Service Data Adaptation Protocol (SDAP), and/or Packet Data Convergence Protocol (PDCP) sublayers of the RAN. The DU may be a logical node hosting Radio Link Control (RLC), Media Access Control (MAC), and Physical (PHY) sublayers of the RAN. A single DU may host or serve multiple network cells formed by multiple RUs. The RU may be a physical node that converts radio signals from antennas to digital signals that can be transmitted over the Front Haul to a DU. In this regard, a network cell may correspond to one or more radio units responsible for providing wireless coverage and signal transmission within the network cell. To this end, since the disaggregated entities have open protocols and interfaces between them, they can be developed by different vendors.

The O-RAN components (e.g., CU, DU, etc.) may be controlled or optimized by one or more radio access network (RAN) intelligent controllers (RICs), such as a Non-real-time (Non-RT) RIC and near-real-time (Near-RT) RIC. The Non-RT RIC may communicate with the Near-RT RIC via an A1 interface in the O-RAN architecture. In this regard, the Non-RT RIC may provide policy-based management or control to the Near-RT RIC by providing one or more A1 policies thereto.

In the related art, the A1 policies are policies constructed to guide the RAN performance towards high-level goals expressed in RAN intent. In this regard, the A1 policies in the related art are declarative policies that contain statements on policy objectives and policy resources applicable to network nodes such as, for example, user equipment (UE) and cells. These A1 policies in the related art, however, merely include information and scope that define “what” objective to achieve (e.g., an amount of energy conservation as defined in an energy-saving policy, a minimum throughput as defined in a quality of service (QoS) policy, etc.), but not “how” to achieve that objective (e.g., how to conserve the amount of energy as defined in the energy-saving policy, how to achieve the minimum throughput as defined in the QoS policy, etc.). This limitation stems from the lack of a specific policy structure that can include and present additional information. As a result, the burden of determining “how” to achieve the objectives of the A1 policies falls on the Near-RT RIC and its associated applications (i.e., xApps), leading to several shortcomings as detailed in the following.

First, in order to ensure minimal latency, the Near-RT RIC and the associated xApps operate in real-time (or near-real-time) and are designed to be lightweight for deployment at the edge. However, edge deployment of the Near-RT RIC may inherently limit the available computational resources, thus the computational resources must be carefully allocated and utilized to support latency-sensitive operations (e.g., traffic steering, handover management, etc.), since inefficient resource utilization could degrade performance, introduce delays, and negatively impact critical functions. Despite this, processing A1 policies often requires complex computations (e.g., leveraging Artificial Intelligence/Machine Learning (AI/ML) technologies to interpret the A1 policy objectives and infer appropriate implementations based thereon, etc.). This can impose significant resource demands on the Near-RT RIC's limited resources, potentially leading to computational constraints, delayed response times, or suboptimal decision-making. Further, the number of Near-RT RIC/xApps that may support the A1 policies may be reduced, leading to potential underutilization of the available RAN resources. For instance, an A1 policy with simple objective/simple implementation (e.g., implementation that does not have strict latency requirement, does not require complex operations, etc.) may potentially be utilized by simple/lightweight xApps or Near-RT RIC that has limited resources, but the AI policy may not be utilized by said xApps/Near-RT RIC in practical due to the restrictions of computational resources required for processing the A1 policies to determine the associated implementation.

Second, the structure of the A1 policies in the related art may be limited in terms of the policy scope and implementation flexibility. Specifically, in certain scenarios or use cases, it is preferable to have imperative information included in the A1 policies to enhance their applicability and effectiveness. For instance, the Non-RT RIC (or the associated rApp) might identify that a Near-RT RIC (or an xApp) from another vendor supports specific functionalities/implementations that may achieve at least a portion of the policy objective, thus including information associated with how to or in what manner the A1 policy can be executed may theoretically optimize the network operation or performance. As another example, the Non-RT RIC (or the associated rApp) may be required to specify detailed operations/actions for the Near-RT RIC (or the associated xApp) in alignment with the network operator's preferences. For instance, in certain scenarios or use cases, the Non-RT RIC (or the associated rApp) may need to provide information on what operations/actions the Near-RT RIC (or the associated xApp) may take when and how such operations/actions should be taken when executing the A1 policies, such as: shutting down a specific cell at a specific time, activating/deactivating a specific feature under a specific condition, etc.). However, these capabilities are restricted in the current A1 policy framework due to its structure, which primarily defines high-level objectives for declarative purposes, without providing actionable implementation details.

Furthermore, the structure of the A1 policies in the related art may also limit their applicability to diverse use cases and necessitate a large number of policies to address different use cases. Specifically, in certain scenarios, a single A1 policy may be associated with multiple use cases, each of which requires implementation by the Near-RT RIC (or the associated xApp) under different conditions. For instance, an A1 policy associated with energy-saving may involve multiple use cases, such as cell shutdown, radio frequency (RF) channel reconfiguration, and the like, each may be triggered or implemented based on different conditions (e.g., counters, thresholds, events, etc.). Additionally, certain use cases might be applied to/avoided from a specific network component (e.g., cell shutdown should be avoided on a specific network node during energy-saving operations, etc.). In the related art, the A1 policies are typically defined at a high level (e.g., an energy-saving policy for a region is applied uniformly across all network nodes in that region) without accommodating detailed or conditional variations. Consequently, multiple A1 policies are required in order to achieve finer control or trigger specific use cases, leading to increased operational complexity and increased load at both the Non-RT RIC and the Near-RT RIC.

Example embodiments of the present disclosure provide a system, a method, a device, and the like, that facilitate the provisioning of enhancement to one or more A1 policies. Specifically, example embodiments implement a Non-RT RIC to generate an A1 policy that has a policy structure that contains new attributes and parameters, which supplement those specified for the A1 policies in the current version of technical specifications provided by the standard organizations like the O-RAN Alliance (e.g., O-RAN.WG2.A1TD), and ultimately enhance the A1 policies and address the shortcomings of the related art systems and methods.

For instance, example embodiments implement the Non-RT RIC to generate and provide an A1 policy that includes a policy type and a policy subtype associated with the policy type, thereby allowing more complex use cases to be specified or defined in one A1 policy. Further, the A1 policy may include one or more conditions associated with the policy subtype, thereby allowing condition-based execution of different use cases under a single A1 policy. These new attributes and parameters provide the A1 policy with the imperative information on how to implement different use cases and the associated operations, thereby enhancing the A1 policy by introducing imperativeness in the A1 policy to enable the A1 policy to be more inclusive, comprehensive, and flexible.

Accordingly, since the A1 policy of the example embodiments may include imperative information, it may be utilized by the Non-RT RIC to provide improved policy guidance. Specifically, the Non-RT RIC may provide more detailed guidance and specific instructions in the A1 policy, thereby offering greater control over the associated network resources and allowing the Near-RT RIC to follow more granular and specific guidance on achieving specific objectives. Further, since the Near-RT RIC (and the associated xApps) could simply rely on the information included in the A1 policy, the burden of processing the A1 policy at the Near-RT RIC can be significantly reduced. As a result, the complexity of developing and implementing the xApps can be simplified and streamlined, especially in cases where less sophisticated xApps can simply follow the guidance of the A1 policy to perform complex tasks.

In addition, since the A1 policy of the example embodiments may include policy subtype(s) associated with a main polity type, a single A1 policy may cover more complex use cases without requiring multiple, separated policies. Accordingly, the enhanced A1 policy of the example embodiments may be applied in various use cases and broader scenarios. As a result, network efficiency (e.g., policy monitoring and execution efficiency, etc.) may be improved since the number of A1 policies, as well as the operations for executing the A1 policies, can be significantly reduced.

Further, since the A1 policy of the example embodiments may include a policy condition(s) associated with the policy subtype, the policy enforcement and execution may be refined. For instance, the A1 policy may be executed based on real-time conditions, which may be particularly useful for operations that depend on real-time factors (e.g., user load, energy consumption, etc.). Further, the A1 policy may be dynamically adapted or triggered based on real-time factors, which may be particularly beneficial for certain operations (e.g., shutting down or activating specific network elements during specific conditions, etc.).

Ultimately, the example embodiments of the present disclosure may efficiently and effectively enhance the A1 policies, thereby simplifying and optimizing policy execution at the Near-RT RIC. Further, example embodiments also provide the user (e.g., network operator) with the flexibility to define the A1 policies in a more granular manner, thereby enabling more specific and detailed control of network resources through the Non-RT RIC. Furthermore, since the Near-RT RIC (and the associated xApps) does not require complex algorithms and large computational resources to implement the A1 policies, the development and implementation of Near-RT RIC (and the associated xApps) can be simplified since simple xApps can be easily developed, implemented, and maintained at the edge location where the associated Near-RT RIC is hosted. In addition, multiple use cases (including use cases that do not require low latency operations) can be effectively and efficiently implemented while reducing the number of A1 policies.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of the example embodiments of the present disclosure are provided in the following.

### Example System Architecture

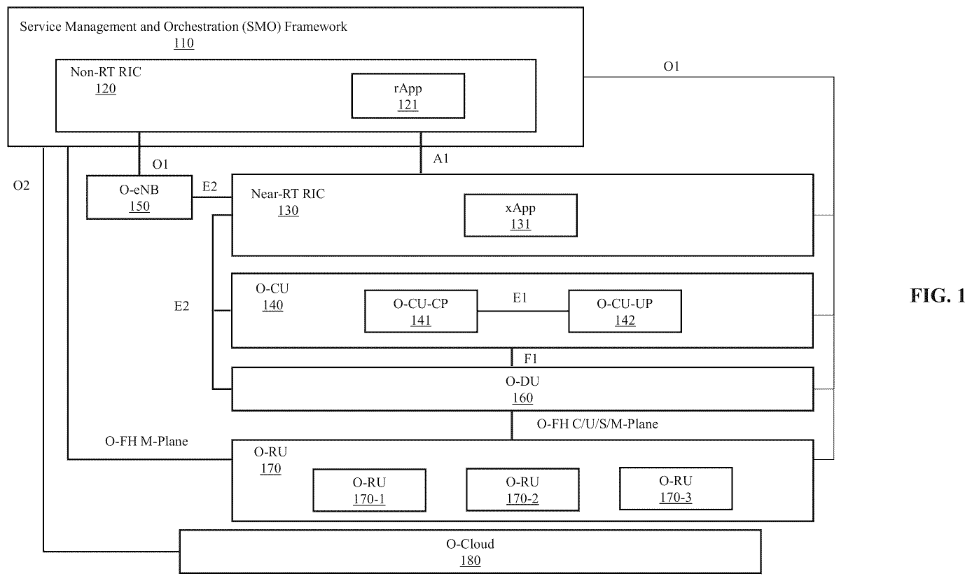

FIG. 1 illustrates an O-RAN architecture in which one or more example embodiments may be applied. As shown in FIG. 1, the system architecture may include at least one Service Management and Orchestration (SMO) framework 110 that includes at least one non-real-time RAN Intelligent Controller (Non-RT RIC) 120, at least one near-real-time RIC (Near-RT RIC) 130, at least one O-RAN Central Unit (O-CU) 140, at least open evolved NodeB (O-eNB) 150, at least one O-RAN Distributed Unit (O-DU) 160, a plurality of O-RAN Radio Units (O-RUs) 170, and at least one O-RAN Cloud (O-Cloud) 180. It is contemplated that the system may include more/fewer components than illustrated, and/or may be configured in a different manner, without departing from the scope of the present disclosure. For instance, in some example implementations, the system architecture may include a plurality of O-DUs 160 each of which may be communicatively coupled to the O-CU 140, and the like.

Generally, the RIC may be a software-defined component that implements modular applications to facilitate multivendor operability, as well as to automate and optimize RAN operations. As shown in FIG. 1, the RIC may be divided into two types, i.e., the Non-RT RIC 120 and the Near-RT RIC 130. In the following, descriptions of the Non-RT RIC 120 are provided, followed by the descriptions of the Near-RT RIC 130.

The Non-RT RIC 120 may refer to a logical function within the SMO framework 110 that drives the content carried across the A1 interface to enable non-real-time control and optimization of RAN elements and resources. The A1 interface may refer to a logical interface between the Non-RT RIC 120 and the Near-RT RIC 130, which enables the Non-RT RIC 120 to provide policy-based guidance to the Near-RT RIC 130 and enables the Near-RT RIC 130 to provide one or more feedback to the Non-RT RIC 120 thereby enabling the Non-RT RIC 120 to monitor the status or implementation of one or more policies.

In some example implementations, the Non-RT RIC 120 may be the control point of a non-real-time control loop and may operate on a timescale greater than 1 second within the SMO framework 110. Generally, the functionalities of the Non-RT RIC 120 may include, for example, providing policy-based guidance and enrichment across the A1 interface, performing data analytics, AI/ML models training and inference for RAN optimization, and/or recommending configuration management actions. In addition, as further described below, the Non-RT RIC 120 may also be configured to generate and provide one or more policies to the Near-RT RIC 130. Further, the Non-RT RIC 120 may access or communicate with other SMO framework functionalities or components via A1 interface, O1 interface, O2 interface, and one or more interfaces associated with one or more open fronthaul planes.

According to example embodiments, the functionalities or operations of the Non-RT RIC 120 may be implemented through at least one modular, Non-RT RIC application, such as the rApp 121. The rApp 121 may leverage the functionalities available in the SMO framework 110 and/or the Non-RT RIC 120 to provide value-added services related to RAN operation and optimization, such as policy management, radio resource management, data analytics, and providing enrichment information. In some example implementations, the Non-RT RIC 120 may implement a plurality of rApps 121.

According to example embodiments, the Non-RT RIC 120 (or the rApp 121 associated therewith) may be configured to generate and provide one or more policies to the Near-RT RIC 130 via the A1 interface, and may be configured to manage one or more policies that are provided to the Near-RT RIC 130 over the A1 interface. Said policies may be referred to as “A1 policies” herein. The Non-RT RIC 120 (or the rApp 121 associated therewith) may create and provide the A1 policies to the Near-RT RIC 130 for execution by the Near-RT RIC 130, thereby providing guidance to the Near-RT RIC 130 towards one or more objectives or goals defined in the RAN intent. The RAN intent may refer to the high-level operational or business goal(s) to be achieved by the RAN, which may be defined by one or more desired service level agreements (SLAs) that the RAN is to fulfill for all users or for a subset of users in a given area over at least a predefined period of time.

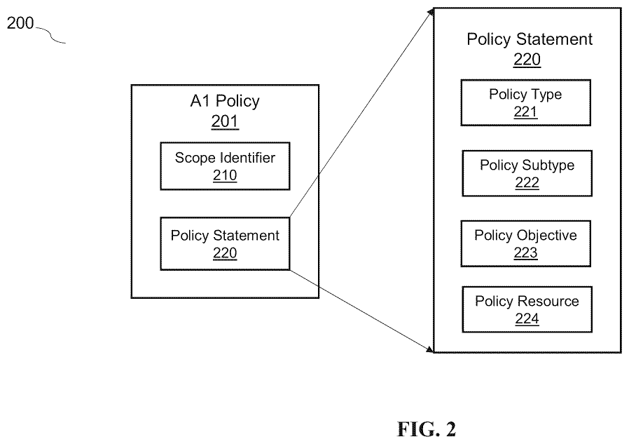

According to example embodiments, the A1 policies may be declarative policies and/or imperative policies that contain information applicable to one or more network nodes (e.g., one or more UEs, one or more network cells, etc.). For instance, the A1 policies may include declarative information focusing on providing guidance on the objective to be achieved by the policies, and/or declarative information defining the operations and conditions for triggering the operations to achieve the objective. Descriptions of example information included in an imperative A1 policy, as well as example policy structures of the A1 policy, are described below with reference to FIG. 2 to FIG. 5.

According to example embodiments, the Non-RT RIC 120 (or the rApp 121 associated therewith) may be configured to perform one or more policy management operations to provide and manage one or more A1 policies. Specifically, the Non-RT RIC 120 (or the rApp 121 associated therewith) may be configured to generate, update, and delete one or more A1 policies. According to example embodiments, the Non-RT RIC 120 (or the rApp 121) may be configured to manage (e.g., generate, update, etc.) an A1 policy based on an associated policy schema. The policy schema may be defined by a user (e.g., a network operator) to define the structure, configuration, and content of the associated policy(s), and may be obtained by the Non-RT RIC 120 (or the rApp 121) when required.

According to example embodiments, the Non-RT RIC 120 (or the rApp 121 associated therewith) may be configured to receive, from the Near-RT RIC 130 via the A1 interface, one or more feedbacks associated with one or more A1 policies (“A1 policy feedback” herein). Similarly, the Non-RT RIC 120 (or the rApp 121 associated therewith) may be configured to receive one or more observables (e.g., events, counters, etc.) provided by the O-CU 140, the O-eNB 150, the O-DU 160, and/or one or more of the O-RUs 170 over the O1 interface. Accordingly, the Non-RT RIC 120 (or the rApp 121 associated therewith) may be configured to continuously (or periodically) manage the one or more A1 policies based on the A1 policy feedback(s) and/or the observables provided over the O1 interface. For instance, the Non-RT RIC 120 (or the rApp 121 associated therewith) may continuously (or periodically) evaluate the impact or effectiveness of the one or more A1 policies towards the fulfillment of the RAN intent and then configure or update the one or more A1 policies accordingly.

In addition to the communication with the Near-RT-RIC 130 via the A1 interface, the SMO framework 110 (as well as the Non-RT RIC 120 and/or the rApp 121 implemented therein) may communicate with the Near-RT RIC 130, the O-CU 140, the O-eNB 150, the O-DU 160, and/or the O-RU(s) 170 via the O1 interface. In this regard, the O1 interface may refer to a logical interface between the SMO framework 110, the Near-RT RIC 130, the O-CU 140, the O-eNB 150, the O-DU 160, and the O-RU(s) 170, which enables the SMO framework 110 (as well as the Non-RT RIC 120 and the rApp 121 implemented therein) to provide Fault, Configuration, Accounting, Performance, and Security (FCAPS) and other management operations, such as network monitoring, network discovery, and the like, to the Near-RT RIC 130, the O-CU 140, the O-eNB 150, the O-DU 160, and/or the O-RU(s) 170. Additionally, the O1 interface enables the Near-RT RIC 130, the O-CU 140, the O-eNB 150, the O-DU 160, and/or the O-RU(s) 170 to provide information or observable(s) that may be utilized by the Non-RT RIC 120 (or the rApp 121 associated therewith) to manage one or more A1 policies, to train one or more AI/ML models, and the like.

Further, the SMO framework 110 (as well as the Non-RT RIC 120 and/or the rApp 121 implemented therein) may communicate with the O-Cloud 180 via the O2 interface. In this regard, the O2 interface may refer to a logical interface between the SMO framework 110 and the O-Cloud 180, which may be a collection of physical RAN nodes that host the Non-RT RIC 120, the Near-RT RIC 130, the O-CU 140, and the O-DU 160, the supporting software components (e.g., the operating systems and runtime environments), and the SMO framework 110 itself. In other words, the SMO framework 110 may manage the O-Cloud 180 from within, and the O2 interface may be the interface between the SMO framework 110 and the O-Cloud 180 it resides in. Through the O2 interface, the SMO framework 110 (as well as the Non-RT RIC 120 and/or the rApp 121 implemented therein) may provide infrastructure management services (IMS) and deployment management services (DMS) for the O-Cloud 180.

Furthermore, the SMO framework 110 (as well as the Non-RT RIC 120 and/or the rApp 121 implemented therein) may also communicate with the O-RU(s) 170 via an open fronthaul (O-FH) management plane (M-Plane) interface. In this regard, the O-FH M-Plane may enable the SMO framework 110 (as well as the Non-RT RIC 120 and/or the rApp 121 implemented therein) to perform one or more FCAPS operations on the O-RU(s) 170.

Next, the descriptions of the Near-RT RIC 130 are provided. The Near-RT RIC 130 may refer to a logical function that enables near-real-time control and optimization of RAN elements and resources. For instance, the Near-RT RIC 130 may provide near-real-time control and optimization via fine-grained (e.g., UE basis, Cell basis, etc.) data collection and actions over the E2 interface. In some example implementations, the Near-RT RIC 130 may operate on a timescale between 10 milliseconds and 1 second and may be coupled with the O-CU 140, the O-eNB 150, and the O-DU 160 via the E2 interface. The Near-RT RIC 130 may use the E2 interface to control the underlying RAN elements (E2 nodes/network functions (NFs)) over a near-real-time control loop.

According to example embodiments, the Near-RT RIC 130 may be configured to execute one or more A1 policies provided by the Non-RT RIC 120 and then perform (based on the one or more A1 policies) one or more operations based thereon. For instance, assuming that the A1 policies are associated with energy-saving, the Near-RT RIC 130 may perform energy-saving related operations (e.g., cell shut down, RF channel configuration, etc.) based on the A1 policies. Further, the Near-RT RIC 130 may monitor, suspend/stop, override, and control the E2 nodes (e.g., O-CU 140, O-DU 160, etc.) via utilizing one or more A1 policies. For example, if the A1 policies do not include imperative information, the Near-RT RIC 130 may receive the one or more A1 policies from the Non-RT RIC 120 (or the rApp 121 associated therewith), and then interpret the received A1 policy(s) to determine one or more control operations and perform the control operation(s) thereafter. In this regard, upon receiving the A1 policy(s), the Near-RT RIC 130 may collect one or more measurement data from one or more E2 nodes (e.g., O-CU 140, O-eNB 150, O-DU 160, etc.) via the E2 interface, and then determine (e.g., by performing AI/ML inference based on the received A1 policy(s) and the collected measurement data, etc.) the one or more control operations thereafter. On the other hand, if the A1 policies include the imperative information, the Near-RT RIC 130 may simply follow the control operations defined or specified by the imperative information. Subsequently, the Near-RT RIC 130 may generate and send one or more control messages to one or more E2 nodes and/or one or more of the O-RUs 170. Accordingly, the E2 node(s) and/or the O-RU(s) may be configured to update their associated configurations to execute one or more operations according to the control messages provided by the Near-RIC 130.

According to example embodiments, the Near-RT RIC 130 may host or implement one or more applications, such as the xApp 131, to implement the associated functions or operations described herein. In this regard, the xApp 131 may consist of one or more microservices, which may be independent of the Near-RT RIC 130 and may be provided by any third party. The E2 interface may enable a direct association between the xApp 131 and other RAN functionalities (e.g., O-CU 140, O-eNB 150, O-DU 160, etc.), thereby enabling the xApp 131 to provide information or data to the RAN functionalities for further utilization. According to example embodiments, the Near-RT RIC 130 may consist of multiple xApps 131 and a set of platform functions that are commonly used to support the specific functions hosted by the multiple xApps 131. In this regard, the Near-RT RIC platform may communicate with the xApp(s) 131 via one or more application programming interfaces (APIs). Further, the Near-RT RIC platform may be configured to route A1 policy management messages to the registered xApps based on A1 policy type and operator policies.

Next, the descriptions of the O-CU 140, the O-eNB 150, the O-DU 160, and the O-RU 170 are provided. Generally, the O-CU 140, the O-DU 160, and the O-RU 170 may constitute a base station, such as a gNodeB (gNB) of 5G NR or a node in Next Generation Radio Access Network (NG-RAN), a base station of a 6G network, and the like. On the other hand, the O-eNB 150 may refer to a 4G LTE version of the O-RAN-compliant node (e.g., an eNB that adheres to the O-RAN architecture).

The communication between the O-CU 140 and the O-DU 160 may be performed via an F1 interface, while the communication between the O-DU 160 and the O-RU 170 may be performed via one or more O-FH Control (C), User (U), Synchronization(S), and Management (M) plane interfaces. In some example implementations, the C, U, and S planes may be consolidated and referred to as the “CUS-plane”. According to example embodiments, the system may include a plurality of O-DUs 160, and the O-CU 140 may be communicatively coupled to the plurality of O-DUs via the F1 interface. Similarly, the system may include a plurality of O-RUs 170, and the O-DU(s) 160 may be communicatively coupled to the plurality of O-RUs via one or more of the O-FH C/U/S/M plane interfaces.

According to example embodiments, the O-CU 140 and the O-DU 160 may be defined in software form and may be deployed in one or more network nodes. For instance, the O-CU 140 and the O-DU 160 may be deployed in one or more servers in the form of virtualized network function (VNF), containerized and/or cloud-native function (CNF), and the like. According to example embodiments, the O-CU 140 and the O-DU 160 may be deployed in the same node (e.g., same server) and/or may be located at a similar geographical location (e.g., be deployed in different servers in the same data center). According to embodiments, the O-CU 140 and the O-DU 160 may be deployed in different nodes and/or may be located at different geographical locations. For instance, the O-CU 140 may be deployed in one or more central servers (i.e., servers in one or more central data centers), and the O-DU 160 may be deployed in one or more edge servers (i.e., servers in one or more edge data centers).

The O-DU 160 may receive radio signals from an end user (via one or more UEs and one or more cells) and may provide operation or support for lower layers of protocol stacks (e.g., RLC layer, MAC layer, Physical Layer, etc.) accordingly. As an example, the O-DU 160 may perform one or more scheduling operations. The O-CU 140 may communicatively couple the O-DU 160 to a core network (e.g., 4G Evolved Packet Core (EPC) network, 5G Core network, etc.) and may receive the radio signals from the O-DU 160, thereby providing operation or support for higher layers of protocol stacks (e.g., PDCP layer, RRC layer, etc.) accordingly.

According to example embodiments, the O-CU 140 may include an O-CU control plane (O-CU-CP) 141 and an O-CU user plane (O-CU-UP) 142. The O-CU-CP 141 may refer to the logical node that hosts or implements the RRC and the control plane part of the PDCP protocol, and may be responsible for managing the signaling between the core network and the radio network, handling tasks such as session management, radio bearer control, and mobility management. On the other hand, the O-CU-UP 142 may refer to the logical node that hosts or implements the user plane part of the PDCP protocol and the SDAP protocol, and may be responsible for managing the data traffic and the transmission of user data packets. The O-CU-CP 141 and the O-CU-UP 142 may be coupled to each other via the E1 interface.

Further, a single O-DU 160 may host or serve multiple network cells formed by multiple O-RUs 170. According to example embodiments, the O-DU 160 may implement various radio technologies, such as massive multiple-input multiple-output (MIMO), beamforming, and the like, to optimize radio communication among the multiple cells and the O-CU 140. In some example implementations, the O-DU 160 may concurrently host or serve hundreds (e.g., 512, etc.) of cells at a time.

The O-RU(s) 170 may be a physical node that converts radio signals from antennas to digital signals that can be transmitted over the Front Haul to the O-DU 160. In this regard, a network cell described herein may correspond to one or more radio units responsible for providing wireless coverage and signal transmission within the network cell. The network cell may include a macro cell, a micro cell, a pico cell, a femto cell, and/or any other suitable type of network cell. Each of the cells may have an associated coverage area, in which at least one O-RU 170, at least one antenna system, and any other suitable type of transport network element (TNE), may be deployed therein.

According to example embodiments, the O-DU 160 may be configured to control or instruct the associated O-RU(s) via one or more of the O-FH C/U/S/M plane interfaces. For instance, the O-DU 160 may instruct the O-RU(s) 170 to shut down or enter sleep mode via the O-FH C/U/S plane interfaces. On the other hand, the capability exchange between the SMO 110 and the O-RU(s) 170 may be performed via the O-FH M-plane interface. As an example, the O-RU(s) 170 may inform the SMO 110 of the amount of time it requires to maintain in sleep mode (or off mode) in order to save an amount of energy, and the like.

In view of the above, example embodiments of the present disclosure introduce a system for facilitating the provisioning enhancement on one or more A1 policies in the O-RAN architecture. Specifically, the Non-RT RIC 120 may be utilized to generate A1 policies that include imperative information, and then provide the A1 policies to the Near-RT RIC 130. Subsequently, the Near-RT RIC 130 may simply implement the associated operations defined in the A1 policies. Further details of the A1 policies, according to one or more example embodiments, are provided in the following.

### Example Policy Contents & Policy Structures

As described above, example embodiments of the present disclosure may provide the enhancement of one or more A1 policies. Specifically, example embodiments provide a system that includes a Non-RT RIC (or an apparatus/device that implements the Non-RT RIC) configured to generate A1 policies and then provide the A1 policies to a Near-RT RIC for execution.

In this regard, example embodiments introduce new policy structures, attributes, and parameters for defining and specifying the A1 policies. These new policy structures, attributes, and parameters supplement those specified for the A1 policies in the current version of technical specifications provided by the standard organizations like the O-RAN Alliance (e.g., O-RAN.WG2.A1TD), and enable the inclusion of imperative information in the A1 policies. In addition, in some example embodiments, the Non-RT RIC (or an rApp associated therewith) may be configured to obtain a policy schema and then generate the A1 policy based on the policy schema. In this regard, example embodiments introduce a new policy schema that includes new structural configurations, attributes, and parameters associated with the inclusion of imperative information in A1 policies. In the following, descriptions of the example contents, structures, and policy schema associated with the A1 policies, according to one or more example embodiments, are provided.

FIG. 2 illustrates a block diagram 200 of a generic policy structure of an A1 policy, according to one or more example embodiments. As illustrated in FIG. 2, an A1 policy 201 may include a scope identifier 210 and a policy statement 220.

The scope identifier 210 may specify or define at least one node or network entity to which the A1 policy 201 can be applied. According to example embodiments, the scope identifier 210 may include information associated with a specific cell or region of the network (e.g., cell ID, tracking area, etc.), information associated with a user or a user group (e.g., UE information, user categories, user ID, etc.), information associated with a network slice (e.g., slide ID, etc.), and the like.

According to example embodiments, the scope identifier 210 may be specified or defined according to network levels or layers. For instance, the scope identifier 210 may be specified or defined according to the node level, and may thus include information associated with a network node, such as: a UE ID, a gNB ID, an O-RU ID, an O-DU ID, an O-CU ID, a group ID associated with a plurality of UEs, a gNB ID list that includes a plurality of gNB IDs, an O-RU ID list that includes a plurality of O-RU IDs, an O-DU ID list that includes a plurality of O-DU IDs, and/or an O-CU ID list that includes a plurality of O-CU IDs. As another example, the scope identifier 210 may be specified or defined according to the network level and may include a network ID (e.g., a public land mobile network (PLMN) ID, etc.) and/or a network ID list that includes a plurality of network IDs, according to the cell level and may include a cell ID and/or a cell ID list that includes a plurality of cell IDs, according to the slice level and may include a slice ID associated with a network slice and/or a slice ID list that includes a plurality of slice IDs, and the like. According to example embodiments, the scope identifier may be defined or specified according to multiple network levels or layers. By specifying the scope identifier based on the network levels or layers, the A1 associated policy may be specified and defined for controlling or optimizing operations in various network levels or layers (e.g., cell level, slice level, node level, network level, etc.).

On the other hand, the policy statement 220 may include declarative and/or imperative information that specifies or defines the targets, goals, or objectives of the A1 policy 201, and also specifies or defines operation(s) for implementing the A1 policy 201. As illustrated in FIG. 2, the policy statement 220 may include a policy type 221, a policy subtype 222, a policy objective 223, and a policy resource 224.

The policy type 221 may specify or define a high-level objective or a functional category of the policy 201. According to example embodiments, the policy type 221 may include: a network energy-saving (NES) policy, a load balancing policy, a QoS policy, a mobility management policy, a network slice management policy, a traffic steering policy, a UE power-saving policy, an anomaly detection policy, a network fault management policy, a security assurance policy, and/or any other suitable type of policy. As further described below, according to example embodiments, a single policy may include multiple policy types (e.g., the policy statement 220 of the A1 policy 201 may include a plurality of policy types 221, etc.).

The policy subtype 222 may be associated with the policy type 221. Specifically, the policy subtype 222 may define or specify a more granular or detailed operation/mechanism within the scope of the policy type 221. According to example embodiments, the policy subtype 222 may include attributes or parameters associated with a use case of the policy type 221. For instance, assuming that the policy type 221 is “NES” (i.e., the A1 policy 201 is associated with energy-saving), the policy subtype 222 may define or specify a use case of “Cell Shut Down” that shutting down a cell to achieve a specific energy-saving related objective. As further described below, according to example embodiments, a single policy may include multiple policy subtypes (e.g., the policy statement 220 of the A1 policy 201 may include a plurality of policy subtypes 222, etc.), each of which may be associated with one or more policy type.

The policy objective 223 may define or specify an objective of the A1 policy 201. According to example embodiments, the policy objective 223 may be associated with the policy type 221 and/or the policy subtype 222. For instance, assuming that the policy type 221 is “NES” (i.e., the A1 policy 201 is associated with energy-saving) and the policy subtype 222 defines a use case of “Cell Shut Down”, the policy objective 223 may define or specify an energy-saving-related objective to be achieved via shutting down one or more cells. A non-limiting list of example energy-saving-related objectives are: an energy-saving objective (may be referred to as “ES” or “EsObjective” herein), an energy consumption objective (may be referred to as “EC” or “EcObjective” herein), an energy efficiency objective (may be referred to as “EE” or “EeObjective” herein), a RAN energy consumption objective (may be referred to as “ECNG-RAN” herein), a gNB energy consumption objective (may be referred to as “ECgNB” herein), a network service energy consumption objective (may be referred to as “ECns” herein), a network function energy consumption objective (may be referred to as “ECNF” herein), and a QoS objective. According to example embodiments, the policy objective 223 may be defined or specified by an associated policy condition, or vice versa. Alternatively, the policy objective 223 may include the policy condition.

The policy resource 224 may define or specify a resource that can and/or cannot be utilized to achieve the policy objective 223. For instance, assuming that the policy objective 223 defines a target energy-saving objective through cell shutdown, the policy resource 224 may define or specify the cell(s) that can and/or cannot be shut down for energy-saving purposes. In this regard, the policy resource 224 may include a cell ID, a cell ID list that includes a plurality of Cell IDs, and the like. According to example embodiments, policy resource 224 may include an inclusion list that includes information of one or more nodes that can be utilized and can be included in the operations to achieve the policy objective, and/or an exclusion list that includes information of one or more nodes that cannot be utilized and should be excluded from the operations to achieve the policy objective. According to example embodiments, the policy resource 224 may be defined or specified by an associated policy condition, or vice versa. Alternatively, the policy resource 224 may include the policy condition.

According to example embodiments, the policy statement 220 may further include a policy condition that defines or specifies a condition under which the policy statement 220 should be triggered or enforced.

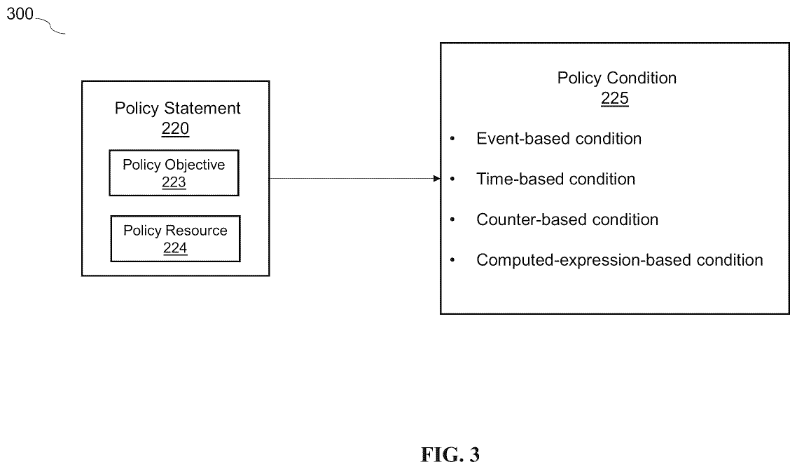

FIG. 3 illustrates a block diagram of the relationship between the policy statement 220 and a policy condition 225, according to one or more example embodiments. As illustrated in FIG. 3, the policy condition 225 may include at least one of: an event-based condition, a time-based condition, a counter-based condition, and a computed-expression-based condition.

According to example embodiments, the event-based condition may refer to a condition that may be triggered according to the occurrence or completion of an event. For instance, the event-based condition may include a condition based on a network event (e.g., policy objective/resource activated based on detection of a specific amount of cell congestion, detection of network failure, activation of a new network slice, initiation of a UE handover, etc.), a condition based on a device event (e.g., policy objective/resource activated based on detection of a network device switches to energy-saving mode, detection of mobility state change of the network device, etc.), a condition based on an emergency event (e.g., policy objective/resource activated based on reception of natural disaster information, etc.), a condition based on a scheduled event (e.g., policy objective/resource activated based on scheduled network maintenance, scheduled mass events like concerts and sport matches, etc.), and/or a condition based on any other suitable type of event that may trigger or activate the policy objective and/or policy resource.

According to example embodiments, the time-based condition may refer to a condition that may be triggered upon the starting or elapsing of a timing configuration. For instance, the time-based condition may include a condition based on a specific time (e.g., policy objective/resource activated during peak hours/low traffic hours, activation during night-time/day-time, etc.), a condition based on a specific period (e.g., policy objective/resource activated hourly/daily/weekly/monthly, etc.), a condition based on a time window (e.g., policy objective/resource activated during a scheduled time window, etc.), and/or a condition based on any other suitable timing configuration that may trigger or activate the policy objective and/or policy resource.

According to example embodiments, the counter-based condition may refer to a condition that may be triggered by a specific threshold or count. For instance, the counter-based condition may include a condition based on the number of network devices (e.g., policy objective/resource activated when the number of active UEs exceeds a predefined number, when the number of idle network nodes is less than a predefined number, etc.), a condition based on the traffic volume (e.g., policy objective/resource activated when the total network traffic exceeds a predefined volume, when the throughput of a network slide exceeds a predefined threshold, etc.), a condition based on the network latency (e.g., policy objective/resource activated when the network latency exceeds a predefined threshold, etc.), and/or a condition based on any other suitable counter/threshold configuration that may trigger or activate the policy objective and/or policy resource.

According to example embodiments, the computed-expression-based condition may refer to a condition that may be triggered by one or more computed expressions. In some example embodiments, the computed expression(s) may include a logical rule(s) that is defined by a combination of conditions, an operator(s), and/or a Boolean value(s). For instance, the logical rule(s) may be a combination of an event-based condition and a counter-based condition, that may be defined by an “AND” logical operator, a “=” relational operator, and a “TRUE” Boolean value (e.g., “when event A occurs AND when threshold B exceeds C %=TRUE”, etc.). It is contemplated that the logical rule(s) may be a combination of any suitable type of conditions (e.g., a combination of event-based condition(s), time-based condition(s), counter-based condition(s), and/or operator-based condition(s), etc.), a combination of more than two conditions, may include any suitable type of operators (e.g., any suitable type of logical operators such as “AND”, “OR”, and “NOT”, any suitable type of preference operators such as “SHALL”, “PREFER”, “AVOID”, and “FORBID”, any suitable type of relational operators such as “=”, “!=”, “>”, “<”, “>=”, “<=”, and “!=”, any suitable type of arithmetic operators such as “+”, “−”, “x”/“*”, “÷”/“/”, and “%”, any suitable type of Bitwise operators such as “&”, “|”, “\hat{ }”, “˜”, “<<”, and “>>”, etc.), may include any suitable number of operators, and/or may include any suitable combination of the operators.

According to example embodiments, the policy condition 225 may be associated with at least one of the policy objective 223 and the policy resource 224. For instance, the policy condition 225 may include one or more policy conditions that are associated with either one of the policy objective 223 and the policy resource 224, or may include one or more conditions that are associated with both the policy objective 223 and the policy resource 224.

According to example embodiments, the policy condition 225 may include a plurality of policy conditions. The plurality of policy conditions may be of the same condition type (e.g., event-based, time-based, counter-based, computed-expression-based, etc.) or different condition types. Further, a first policy condition (or a first portion) of the plurality of policy conditions may be associated with the policy objective 223, while a second policy condition (or a second portion) of the plurality of policy conditions may be associated with the policy resources.

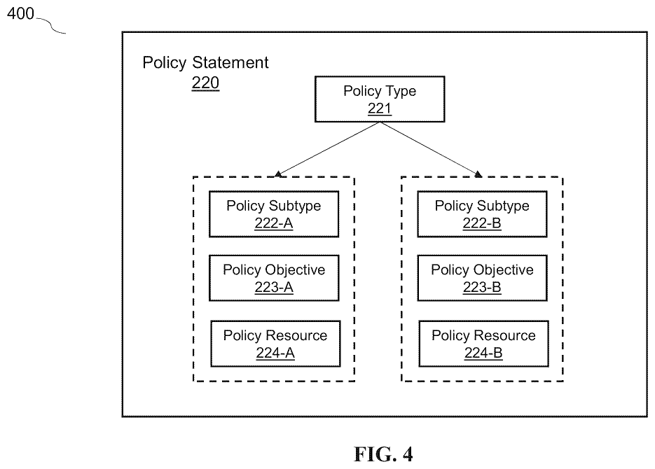

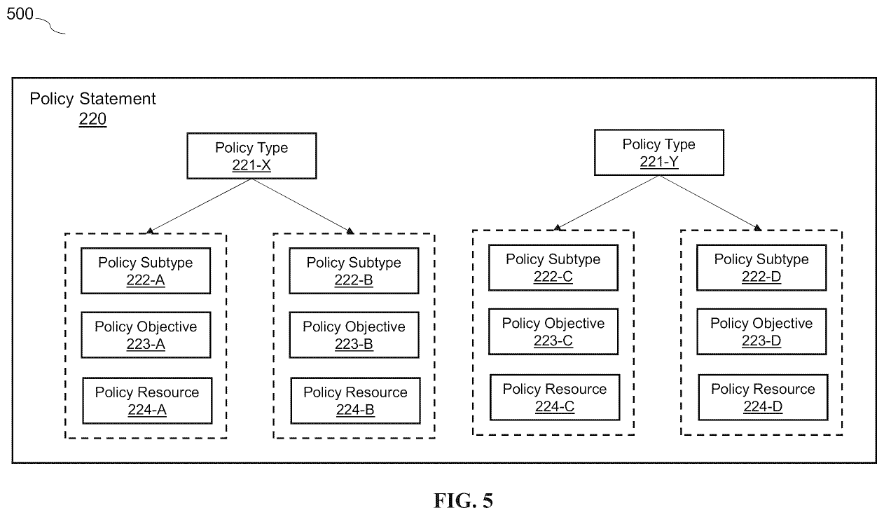

Next, several example policy structures showing the potential relationship among the policy type 221, policy subtype 222, policy objective 223, and policy resource 224, according to one or more example embodiments, are described in the following with reference to FIG. 4 and FIG. 5.

FIG. 4 illustrates a block diagram 400 of a first example policy structure, according to one or more example embodiments. In this example policy structure, the policy statement 220 includes one policy type 221, a plurality of policy subtypes 222-A and 222-B, a plurality of policy objectives 223-A and 223-B, and a plurality of policy resources 224-A and 224-B.

As illustrated in FIG. 4, the policy subtype 222-A and policy subtype 222-B may both be associated with the policy type 221, while the policy objective 223-A and policy resource 224-A may be associated with the policy subtype 222-A, and the policy objective 223-B and policy resource 224-B may be associated with the policy subtype 224-B. For illustrative purposes, the associated or interrelated components are grouped in dotted lines in FIG. 4.

According to example embodiments, policy subtype 222-A may define or be associated with a first use case of the policy type 221, while policy subtype 222-B may define or be associated with a second use case of the policy type 221. As a non-limiting example, assuming that the policy type 221 is “NES”, the policy subtype 222-A may be “Cell Shut Down” and the policy subtype 222-B may be “RF Channel Configuration”. In this case, the policy objective 223-A may define or specify a first energy-saving related objective (e.g., energy-saving objective, energy consumption objective, energy efficiency objective, etc.) to be achieved via shutting down one or more cells, and the policy resource 224-A may define or specify the cell(s) that can and/or cannot be shut down to achieve the first energy-saving related objective. On the other hand, the policy objective 223-B may define or specify a second energy-saving related objective to be achieved via configuring one or more RF channels, and the policy resource 224-B may define or specify the RF channel(s) that can and/or cannot be configured to achieve the second energy-saving related objective. One or more of the policy objective 223-A, policy objective 223-B, policy resource 224-A, and policy resource 224-B, may have a policy condition(s) associated therewith.

FIG. 5 illustrates a block diagram 500 of a second example policy structure, according to one or more example embodiments. In this example policy structure, the policy statement 220 includes a plurality of policy types 221-X and 221-Y, a plurality of policy subtypes 222-A to 222-D, a plurality of policy objectives 223-A to 223-D, and a plurality of policy resources 224-A to 224-D.

According to example embodiments, the policy type 221-X and the policy type 221-Y may be associated with each other. For instance, policy type 221-X and policy type 221-Y may both be associated with the same policy type (e.g., NES, load-balancing, etc.), may both be associated with a network component to which the policy statement 220 is applicable, may both associated to a network operation, may both be associated with the same Near-RT RIC (or an associated xApp), and the like.

Similar to those described with reference to FIG. 4, the policy subtype 222-A and policy subtype 222-B may be associated with the policy type 221-X, while the policy objective 223-A and policy resource 224-A may be associated with the policy subtype 222-A, and the policy objective 223-B and policy resource 224-B may be associated with the policy subtype 222-B. In addition, as illustrated in FIG. 5, the policy subtype 222-C and policy subtype 222-D may be associated with the policy type 221-Y, while the policy objective 223-C and policy resource 224-C may be associated with the policy subtype 222-C, and the policy objective 223-D and policy resource 224-D may be associated with the policy subtype 222-D. For illustrative purposes, the associated or interrelated components are grouped in dotted lines in FIG. 5.

According to example embodiments, the structure and/or contents of the A1 policy, such as the parameters and characteristics of the policy type(s) 221, the policy subtype(s) 222, the policy objective(s) 223, the policy resource(s) 224, and the policy condition(s) 225, as well as the relationship thereof, may be defined or outlined by a policy schema. According to example embodiments, the policy schema may be defined in the format of JavaScript Object Notation (JSON). In that case, the associated A1 policy(s) may be generated or defined by the Non-RT RIC 120 (or the associated rApp) based on the JSON-based policy schema. In operations, the policy schema may be predefined by a user (e.g., a network operator) and may be provided to the Non-RT RIC 120 (or the associated rApp) by the user. Alternatively or additionally, the Non-RT RIC 120 may periodically (or continuously) obtain the latest version of policy schema from the user (or a device or UE associated therewith). Accordingly, the Non-RT RIC 120 may utilize the policy schema to manage (e.g., define, generate, update, etc.) the associated A1 policy(s) when required.

Next, an example A1 policy, according to one or more embodiments, is described below with reference to the following Table. 1. This example A1 policy includes two policy types, each of which has different parameters (e.g., policy subtype, scope identifier, policy objective, policy resource, policy condition, etc.) associated therewith. For descriptive purposes, the parameters associated with the first policy type (i.e., NES) are presented in italic form, while the parameters associated with the second policy type (i.e., Load Balancing) are presented in bold form.

TABLE 1
Example A1 Policy

```
policy_type″: “NES″,
  ″policy_subtype″: “NES.A″,
  ″policy_id″: ″1″,
    ″scope″: {
      ″slice_id″: ″1″,
      “cell_id″: “X″,
    },
  “ESObjectives″: [
      “ESCondition”: {
            “activeusers” “=< “ 1”“AND”
            “EC“=> ” 60 “
          }
      }
    ]
  “EsResources″: {
  ″cellIdList″: [
      {″plmnId″: {″mcc″: ″123″,″mnc″: ″45″}, ″cId″: {″ncI″: 32}},
      {″plmnId″: {″mcc″: ″123″,″mnc″: ″45″}, ″cId″: {″ncI″: 33}},
      {″plmnId″: {″mcc″: ″123″,″mnc″: ″45″}, ″cId″: {″ncI″: 34}}
          ]
      ″preference″: ″SHALL“
        “PolicyValidityPeriod ”:[
              {“periodOfDay ”= “ ”12:30to14:30”}
              {“daysOfWeekList” “= “ “Monday,Friday”}
              ]
        }
}
″policy_type″: ″LoadBalancing″,
″policy_subtype″: ″LB.B″,
″policy_id″: ″4″,
″scope″: {
    ″slice_id″: ″4″,
    ″cell_id″: ″A″
},
″LBObjectives″: [
    ″LBCondition″: {
        ″activeusers″ ″>= 100″ ″AND″
        ″avgThroughput″ ″<= 50Mbps″
    }
]
″LBResources″: {
    ″cellIdList″: [
        {″plmnId″: {″mcc″: ″321″,″mnc″: ″12″}, ″cId″: {″ncI″: 87}},
        {″plmnId″: {″mcc″: ″321″,″mnc″: ″12″}, ″cId″: {″ncI″: 88}},
        {″plmnId″: {″mcc″: ″321″,″mnc″: ″12″}, ″cId″: {″ncI″: 89}}
    ],
    ″preference″: “SHALL″,
    ″PolicyValidityPeriod″: [
        {″periodOfDay″: ″09:00to21:00″},
        {″daysOfWeekList″: ″= Friday,Saturday″}
    ]
}
```

In the example A1 policy of Table 1, the first policy type is associated with network energy-saving (illustrated as “NES” in Table 1) and has a first policy subtype (illustrated as “NES. A” in Table 1) associated therewith, the policy subtype may be associated with or specify a specific operation/use case associated with network-energy-saving (e.g., cell shut down, RF channel reconfiguration, etc.). The scope identifier (illustrated as “scope” in Table 1) associated with the first policy type includes a slice ID that defines the specific network slice(s) to which the energy-saving related policy and operations are applicable, and a cell ID that defines the specific cell(s) to which the energy-saving related policy and operations are applicable.

The policy objective associated with the first policy subtype (illustrated as “ESObjectives” in Table 1) includes a combination of multiple policy conditions (illustrated as “ESCondition” in Table 1), such as a combination of a first policy condition “a number of active users equal to or smaller than 1” (illustrated as “activeusers=<1” in Table 1), an “AND” operator, and a second policy condition “energy consumption equal to or greater than 60 units” (illustrated as “EC=>60” in Table 1). In this example, the combination of policy conditions may define the policy objective of the associated policy subtype/use case associated with network energy-saving, i.e., to maintain the number of active users (associated with the network slice(s) and cell(s) defined in the scope identifier) to be greater than 1 (i.e., “activeusers>1”) and keep the energy consumption (associated with the network slice(s) and cell(s) defined in the scope identifier) below 60 units (e.g., W, kW, MW, Wh, W/Gbps, W/User, etc.). In this regard, the combination of policy conditions also provides imperative information that defines when the operations associated with the policy subtype “NES.A” should be triggered, i.e., said operation should be triggered whenever the number of active users is less than or equal to 1, and whenever the energy consumption is greater than or equal to 60 units.

Further, the policy resource associated with the first policy subtype (illustrated as “EsResources” in Table 1) includes a cell ID list (illustrated as “cellIdList” in Table 1) that includes multiple cell IDs (each of which is illustrated as “cld” in Table 1) and information associated with the cell IDs, such as the associated PLMN ID (each of which is illustrated as “plmnId” in Table 1) and the associated mobile country code (illustrated as “mcc” in Table 1) and mobile network code (illustrated as “mnc” in Table 1), the associated neighbor cell lists (each of which is illustrated as “ncl” in Table 1), and the like. Further, the policy resource also includes a preference operator “SHALL”, a first time-based policy condition (illustrated as “periodOfDay” in Table 1) that specifies a time window/period of day (e.g., “12:30 to 14:30” in this example) to which the operations of the policy subtype “NES.A” shall be applied to the cells defined in the cell ID list, and a second time-based policy condition (illustrated as “daysOfWeekList” in Table 1) that specifies the specific days (e.g., “Monday and Friday” in this example) to which the operations of the policy subtype “NES.A” shall be applied to the cells defined in the cell ID list. In this regard, the combination of time-based policy conditions provides imperative information that defines a policy validity period when the operations associated with the policy subtype “NES.A” can be applied to the cells defined in the cell ID list, i.e., said operation shall be applied during 12:30-14:30 of Monday and Friday, whenever the policy conditions of the policy objective are fulfilled.

Referring still to Table 1, the second policy type is associated with load-balancing and has a second policy subtype (illustrated as “LB. B” in Table 1) associated therewith, the policy subtype may be associated with or specify a specific operation/use case associated with load balancing (e.g., UEs handover control, carrier aggregation management, etc.). The scope identifier associated with the second policy type includes a slice ID that defines the specific network slice(s) to which the load-balancing-related policy and operations are applicable, and a cell ID that defines the specific cell(s) to which the load balancing related policy and operations are applicable.

The policy objective associated with the second policy subtype (illustrated as “LBObjectives” in Table 1) includes a combination of multiple policy conditions (illustrated as “LBCondition” in Table 1), such as a combination of a first policy condition “a number of active users equal to or greater than 100” (illustrated as “activeusers=>100” in Table 1), an “AND” operator, and a second condition “an average throughput smaller than or equal to 50 Mbps” (illustrated as “avgThroughput<=50 Mbps” in Table 1). In this example, the combination of policy conditions may define the policy objective of the associated policy subtype/use case associated with load balancing, i.e., to maintain the number of active users (associated with the network slice(s) and cell(s) defined in the scope identifier) to be lower than 100 (i.e., “activeusers<100”) and keep the average throughput (associated with the network slice(s) and cell(s) defined in the scope identifier) above 50 Mbps. In this regard, the combination of policy conditions also provides imperative information that defines when the operations associated with the policy subtype “LB.B” should be triggered, i.e., said operation should be triggered whenever the number of active users is greater than or equal to 100, and whenever the average throughput is lower than or equal to 50 Mbps.

Further, the policy resource associated with the second policy subtype (illustrated as “LBResources” in Table 1) includes a cell ID list (illustrated as “cellIdList” in Table 1) that includes multiple cell IDs (each of which is illustrated as “cld” in Table 1) and information associated with the cell IDs, such as the associated PLMN ID (each of which is illustrated as “plmnId” in Table 1) and the associated mobile country code (illustrated as “mcc” in Table 1) and mobile network code (illustrated as “mnc” in Table 1), the associated neighbor cell lists (each of which is illustrated as “ncl” in Table 1), and the like. Further, the policy resource also includes a preference operator “SHALL”, a first time-based policy condition (illustrated as “periodOfDay” in Table 1) that specifies a time window/period of day (e.g., “09:00 to 21:00” in this example) to which the operations of the policy subtype “LB.B” shall be applied to the cells defined in the cell ID list, and a second time-based policy condition (illustrated as “daysOfWeekList” in Table 1) that specifies the specific days (e.g., “Friday and Saturday” in this example) to which the operations of the policy subtype “LB.B” shall be applied to the cells defined in the cell ID list. In this regard, the combination of time-based policy conditions provides imperative information that defines the policy validity period when the operations associated with the policy subtype “LB.B” shall be applied to the cells defined in the cell ID list, i.e., said operation can be applied during 09:00-21:00 of Friday and Saturday, whenever the policy conditions of the policy objective are fulfilled.

It is contemplated that the structures and contents of the A1 policy illustrated in FIG. 2 to FIG. 5 and Table 1 are merely examples, and the scope of the present disclosure should not be limited thereto. Specifically, the A1 policy may include more/less parameters or content than as illustrated, and/or may be configured in a different manner than as illustrated, without departing from the scope of the present disclosure.

In view of the above, example embodiments of the present disclosure provide new policy structures, attributes, and parameters for defining and specifying the A1 policies and thereby enhancing the A1 policies. These new policy structures, attributes, and parameters enable the inclusion of imperative information in the A1 policies. In addition, example embodiments introduce a new policy schema that includes new structural configurations, attributes, and parameters associated with the inclusion of imperative information in A1 policies. Based on the policy schema, the Non-RT RIC can generate A1 policies that include imperative information, thereby enhancing the implementation of the A1 policies.

### Example Operations

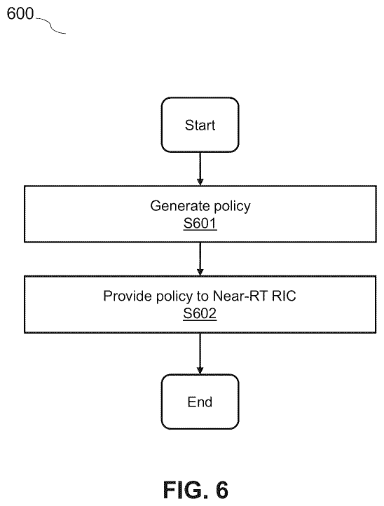

Various operations may be performed by the Non-RT RIC and Near-RT RIC to provide enhancement of A1 policies in an O-RAN-based telecommunication system. Several example operations, according to one or more example embodiments, are described in the following with reference to FIG. 6. One or more operations (or the data involved therein) may be similar to those described above with reference to FIGS. 1-5 and Table 1, thus it may be understood that the described operation(s)/data may be similarly applied to the operations in FIG. 6 (unless described otherwise) and redundant descriptions associated therewith may be omitted for conciseness.

For descriptive purposes, the operations are mainly described as being performed by the Non-RT RIC, although it can be understood that, in actual implementations, the Near-RT RIC may perform similar/related operations from the opposite side, without departing from the scope of the present disclosure. For instance, an operation of the Non-RT RIC sending an A1 policy to the Near-RT RIC may indicate or suggest an operation of the Near-RT RIC receiving the A1 policy from the Non-RT RIC, a description of the A1 policy being executable by the Near-RT RIC to perform one or more operations may indicate or suggest that the Near-RT RIC executes the A1 policy to perform the one or more operations, and the like.

According to example embodiments, the Non-RT RIC and/or the Near-RT RIC may be implemented in one or more hardware components, and one or more operations described hereinbelow may be performed by the one or more hardware components. For instance, the Non-RT RIC and/or the Near-RT RIC may be implemented in a server that includes a processor and a memory storage (or any other suitable storage mediums), wherein the memory storage may include computer-executable instructions which, when being executed by the processor, cause the processor to perform one or more operations described herein. Further, it is contemplated that one or more operations associated with the Non-RT RIC may be implemented by one or more rApps associated with the Non-RT RIC, while one or more operations associated with the Near-RT RIC may be implemented by one or more xApps associated with the Near-RT RIC.

FIG. 6 illustrates a block diagram 600 of an example method for facilitating the provisioning of A1 policy enhancement, according to one or more example embodiments.

As illustrated in FIG. 6, at operation S601, the Non-RT RIC may be configured to generate an A1 policy. In this regard, the operations of generating A1 policy may include modifying/updating an existing A1 policy to thereby obtain a modified/updated A1 policy, or generating a new A1 policy.

In some example embodiments, the Non-RT RIC may be configured to generate the A1 policy based on a policy schema (or any other suitable data/algorithm), thereby ensuring that the A1 policy is standardized and enforceable across different Near-RT RICs (or different xApps). In this case, at operation S601, the Non-RT RIC may be configured to obtain, from a storage medium (e.g., a memory storage of a server that implements the Non-RT RIC, a server dedicated to storing the policy schema, a memory storage of another server that implements another Non-RT RIC, etc.) the policy schema associated with the A1 policy to be generated, and then generate the A1 policy based thereon.

According to example embodiments, the A1 policy is executable or enforceable by a Near-RT RIC. For instance, the Near-RT RIC, upon receiving the A1 policy, may utilize the A1 policy to perform one or more control, management, and/or optimization operations on one or more E2 nodes (e.g., O-CU, O-DU, etc.).

According to example embodiments the A1 policy may include a scope identifier and a policy statement. The scope identifier may define or specify at least one node (e.g., network component, cell, slice, network, etc.). The policy statement may define or specify the content of the A1 policy. For instance, the policy statement may include declarative and/or imperative information that defines or specifies the type(s), subtype(s), objective(s), resource(s), condition(s), and the like, of the A1 policy.

As described above, according to example embodiments, the policy statement of the A1 policy may include a policy type, a policy subtype, a policy objective, a policy resource, and a policy condition.

The policy type may define a type of the A1 policy and provide an indication of the high-level policy objective or classification. In some example embodiments, the policy type may include at least one of: a network energy-saving (NES) policy, a traffic steering policy, a quality of service (QoS) policy, a mobility management policy, a load balancing policy, a network slice management policy, a UE power-saving policy, an anomaly detection policy, a network fault management policy, and a security assurance policy.

The policy subtype may be associated with the policy type. For instance, the policy subtype may define or specify a more granular or detailed operation/mechanism within the scope of the policy type. In some example embodiments, the policy subtype may define, specify, or associate with a use case of the policy type.

According to example embodiments, the policy subtype may include a plurality of policy subtypes. In this regard, the plurality of policy subtypes may be associated with the policy type. In some example embodiments where the policy type includes a plurality of policy types, a first policy subtype (or a first portion) of the plurality of policy subtypes may be associated with a first policy type (or a first portion) of the plurality of policy types, and a second policy subtype (or a second portion) of the plurality of policy subtypes may be associated with a second policy type (or a second portion) of the plurality of policy types

The policy objective may define or specify the objective (e.g., energy-saving objective, load-balancing objective, etc.) of the policy subtype. The policy resource may define or specify a resource that can be utilized to achieve the policy objective. According to example embodiments, the policy statement may include a plurality of policy objectives and/or a plurality of policy resources.

The policy condition may define or specify a condition under which the policy statement can be or should be enforced, and may be associated with at least one of the policy objective and the policy resource. According to example embodiments, the policy condition may include at least one of: an event-based condition, a time-based condition, a counter-based condition, and a computed-expression-based condition.

Further, according to example embodiments, the policy condition may include a plurality of policy conditions. In this regard, all of the plurality of policy conditions may be associated with either one of the policy objective and the policy resource. Alternatively, a first policy condition (or a first portion) of the plurality of policy conditions may be associated with the policy objective, and a second policy condition (or a second portion) of the plurality of policy conditions may be associated with the policy resource.

According to example embodiments, the policy statement may include a plurality of policy subtypes, a plurality of policy objectives and a plurality of policy resources. In this regard, each of the plurality of policy subtypes may have at least one of the plurality of policy objectives and at least one of the plurality of policy resources associated therewith. In this case, the policy condition may be associated with at least one of: the at least one of the plurality of policy objectives and the at least one of the plurality of policy resources.

According to example embodiments, the policy type may include a plurality of policy types, the policy subtype may include a plurality of policy subtypes, the policy objective may include a plurality of policy objectives, and the policy resource may include a plurality of policy resources. In this regard, each of the plurality policy subtypes may be associated with a respective one of the plurality of policy types, and each of the plurality of policy objectives and/or each of the plurality of policy resources may be associated with a respective one of the plurality of policy subtypes. In this case, the policy condition may be associated with at least one of: the at least one of the plurality of policy objectives and the at least one of the plurality of policy resources. Further, if the policy condition includes a plurality of policy conditions, a first policy condition (or a first portion) of the plurality of policy conditions may be associated with at least one of: a first policy objective (or a first portion) of the plurality of policy objectives and a first policy resource (or a first portion) of the plurality of policy resources. In addition, a second policy condition (or a second portion) of the plurality of policy conditions may be associated with at least one of: a second policy objective (or a second portion) of the plurality of policy objectives and a second policy resource (or a second portion) of the plurality of policy resources.

Further descriptions of the example structure, contents, and configurations of the A1 policy have been provided above with reference to FIG. 1-FIG. 5 and Table 1. Thus, redundant descriptions associated therewith may be omitted below for conciseness.

Referring still to FIG. 6, at operation S602, the Non-RT RIC may be configured to provide the A1 policy to the Near-RT RIC. For instance, the Non-RT RIC may provide the A1 policy to the Near-RT RIC via an A1 interface.

According to example embodiments, upon sending the A1 policy to the Near-RT RIC, the Non-RT RIC may be configured to receive one or more feedback from the Near-RT RIC upon execution of the A1 policy. Subsequently, the Non-RT RIC may be configured to generate, based on the feedback(s), another A1 policy (e.g., an updated/fine-tuned A1 policy, a new A1 policy, etc.), and then provide said another A1 policy to the Near-RT RIC for further operations.

In view of the above, example embodiments of the present disclosure provide methods and operations for provisioning enhancement on one or more A1 policies. Specifically, the methods and operations may be implemented by one or more O-RAN components (e.g., Non-RT RIC, etc.) to generate, transmit, manage, and utilize one or more A1 policies that include imperative information, thereby achieving the associated technical advantages. Such technical advantages have been described above, thus redundant descriptions associated therewith may be omitted below for conciseness.

### Example Device

One or more components of the example embodiments (e.g., Non-RT RIC, Near-RT RIC, etc.), as well as the operations associated therewith, may be implemented in one or more devices or hardware components. For instance, one or more components/operations of the Non-RT RIC and/or Near-RT RIC may be implemented in one or more devices like a server(s), a network device(s), and the like.

In the following, descriptions of a device in which the example embodiments may be implemented are provided. It is contemplated that one or more features, operations, and methods described above may be performed by the device. For instance, the one or more operations or methods may be performed by at least one processor of the device upon executing machine-readable instructions or computer-readable instructions stored in a memory or a storage component of the device.

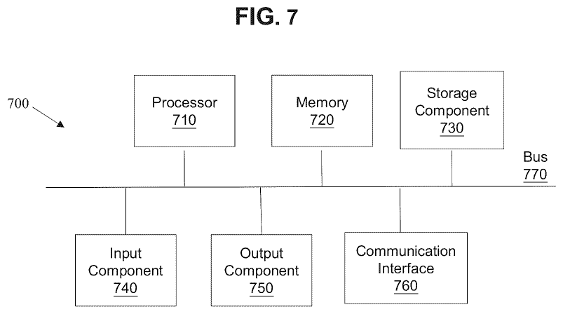

FIG. 7 illustrates a block diagram of an example device 700 for implementing one or more example embodiments. As shown in FIG. 7, the device 700 includes processor 710, a memory 720, a storage component 730, an input component 740, an output component 750, a communication interface 760, and a bus 770.

The processor 710, as used herein, means any type of computational circuit that may comprise hardware elements and software elements. The processor 710 may be embodied as a multi-core processor, a single core processor, or a combination of one or more multi-core processors and/or one or more single core processors, a distributed processing system, or the like. The processor 710 may be a Central Processing Unit (CPU), a graphics processing unit (GPU), an accelerated processing unit (APU), an application-specific integrated circuit (ASIC), or another type of processing component.

Memory 720 includes a non-transitory computer readable medium. Memory 720 includes a random-access memory (RAM), a read only memory (ROM), and/or another type of dynamic or static storage device (e.g., a flash memory, a magnetic memory, and/or an optical memory) that stores information and/or instructions for use by processor 710. The memory 720 comprises machine-readable instructions which are executable by the processor 710. These machine-readable instructions when executed by the processor 710 cause the processor 710 to perform one or more method steps of an embodiment described above.

Storage component 730 stores information and/or software related to the operation and use of the device 700. For example, storage component 730 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 740 is configured to receive information, such as user input. For example, the input component 740 may include, but not be limited to, a touch screen display, a keyboard, a keypad, a mouse, a button, a switch, and/or a microphone. Additionally, or alternatively, the input component 740 may include a sensor for sensing information (e.g., a global positioning system (GPS), an accelerometer, a gyroscope, and/or an actuator).

Output component 750 is configured to provide output information from the device 700. For example, the output component 750 may be, but not limited to, a display, a speaker, an instruction device to an external device, and/or one or more light-emitting diodes (LEDs).

Communication interface 760 is an interface that provides a communication connection to other devices, such as external devices and internal devices. The connection by the communication interface 760 can be a wired connection, a wireless connection, or a combination of wired and wireless connections, and can be a direct connection or an indirect connection via a communication network that exists between the device 700 and other devices. In other words, the standard of the communication interface 760 is not limited.

The bus 770 acts as an interconnect between the processor 710, the memory 720, the storage component 730, the input component 740, the output component 750, and the communication interface 760 of the device 700. The bus 770 may include a wired interconnection or a wireless interconnection.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700. Further, one or more method steps described in any of the embodiments may be performed utilizing a plurality of devices 700 in communication with one another.

### Example Implementation Environment

Example embodiments of the present disclosure may be implemented in any suitable type of environment. In the following, an example environment (in which the example embodiments may be implemented) is described.

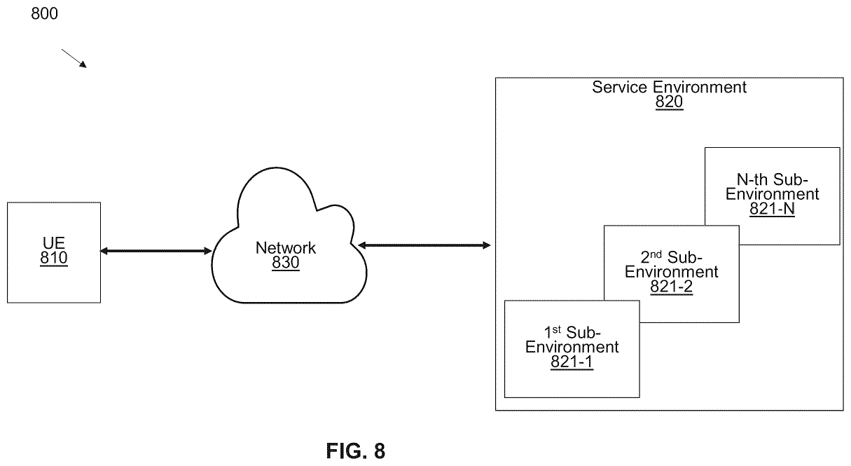

FIG. 8 illustrates a block diagram of an example environment 800 in which systems and/or method, described herein, may be implemented. The implementation environment 800 includes a UE (User equipment) 810, a service environment 820, and a network 830. The service environment 820 includes one or more sub-environments 821. To illustrate this, FIG. 8 shows, for convenience, examples of a 1st sub-environment 821-1, a 2nd sub-environment 821-2, and an N-th sub-environment 821-N (where N is any natural number).

The UE 810 is connected to the network 830, and the network 830 is connected to the service environment 820. The connections may be wired, wireless, or a combination of both wired and wireless. The UE 810 and the service environment 820 are connected via the network 830.

The UE 810 is a device that communicates with the service environment 820. The UE 810 receives information from the service environment 820 and/or sends information to the service environment 820. Also, the UE 810 may generate and/or store information to be transmitted, as necessary. Also, the UE 810 may store and/or process information that is received, as necessary.

The example FIG. 8 refers to the “UE”. However, it should be understood by those skilled in the art that general terms such as “user device,” “terminal,” “terminal device,” “communication device,” and “communication terminal” can be used interchangeably with the term “UE.”

For example, the UE 810 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 820 is an environment that communicates with the UE 810 to provide one or more services. The service environment 820 receives information from the UE 810 and/or sends information to the UE 810. Also, the service environment 820 may generate and/or store information to be transmitted, as necessary. Also, the service environment 820 may store and/or process information that is received, as necessary. For example, the service environment 820 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 8 refers to the “service environment”. The term “service environment” is used to refer to the broader context within which services operate. For example, cloud environments, platforms, computing systems, network systems, and cloud systems generally represent the environments in which services are conducted, and these are included within the “service environment.” However, the “service environment” is not limited to these examples. Additionally, the specific types of environments within the “service environment” are not restricted. For instance, cloud environments and cloud systems can be categorized as private cloud, public cloud, hybrid cloud, or multi-cloud, all of which are included within the “service environment.”

The one or more services provided by the service environment 820 is not specifically limited and can be adjusted according to the embodiments. For example, the services may include a service that provides information to the UE 810, a service that stores information from the UE 810, or a service that performs processing based on information from the UE 810 and returns the results of the processing.

In an embodiment, the Service Environments 820 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as “Virtual” or “Virtualized” to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 820 includes one or more devices, such as servers and network devices, which provide services or perform processes. The placement of these devices within the service environment 820 can be determined as appropriate. Additionally, if the service environment 820 includes one or more sub-environments 821, the placement of devices can be determined based on predetermined policies for each sub-environment 821. For example, devices related to the first service may be placed in the 1st sub-environment 821-1, and devices related to the second service may be placed in the 2nd sub-environment 821-2. In another example, devices expected to have a higher load than a predetermined threshold may be placed in the 1st sub-environment 821-1, while devices expected to have a lower load than the predetermined threshold may be placed in the 2nd sub-environment 821-2. In this way, specific devices can be placed in specific sub-environments 821. Conversely, each sub-environment 821 can be specialized for a particular purpose.

In an embodiment, all processes executed in a single service may run within a single service environment, or in multiple service environments. Multiple processes executed in a single service could be provided by different service environments.

The network 830 is a network that exchanges information between the UE 810 and the service environment 820. The network 830 includes one or more wired and/or wireless networks.

For example, the network 830 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 830 can be a part of a network. For example, in a 5G network that includes a RAN, a transport network, and a core network, the network 830 can be at least one of the RAN, the transport network, or the core network. For example, the service environment 820 could be in the core network, in which case the network 830 could correspond to a network that is a combination of a RAN and a transport network and is part of the 5G network.

The number and arrangement of devices and networks shown in FIG. 8 are provided as an example. It should be understood that any changes that may be implemented by those skilled in the art, such as the addition or rearrangement of well-known devices or networks at the time of implementation, are included in this disclosure.

### VARIOUS ASPECTS OF EMBODIMENTS

It is contemplated that the example embodiments described hereinabove with reference to FIG. 1 to FIG. 8 are merely examples of possible embodiments of the present disclosure, and are not intended to limit or restrict the scope of the present disclosure.

Specifically, the above disclosure provides illustration and description, but is not intended to be exhaustive or to limit the implementations to the precise form disclosed. Modifications and variations are possible in light of the above disclosure or may be acquired from practice of the implementations.

Some embodiments may relate to a device (e.g., a node, etc.), a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

In view of the above, various further respective aspects and features of embodiments of the present disclosure may be defined by the following items:
Item [1]: A system including: a non-real-time (Non-RT) radio access network intelligent controller (RIC) configured to generate an A1 policy executable by a Near-RT RIC, and then provide the A1 policy to the Near-RT RIC via an A1 interface. The A1 policy may include a scope identifier defining at least one node to which the policy can be applied and a policy statement defining the content of the A1 policy. The policy statement may include a policy type defining a type of the A1 policy, a policy subtype associated with the policy type, a policy objective defining an objective of the policy subtype, a policy resource defining a resource that can be utilized to achieve the policy objective, and a policy condition defining a condition under which the policy statement should be enforced. The policy condition may be associated with at least one of the policy objective and the policy resource.
Item [2]: The system according to item [1], wherein the policy condition may include a plurality of policy conditions. A first policy condition of the plurality of policy conditions may be associated with the policy objective. A second policy condition of the plurality of policy conditions may be associated with the policy resource.
Item [3]: The system according to one or more of items [1]-[2], wherein the policy subtype may include a plurality of policy subtypes. The plurality of policy subtypes may be associated with the policy type.
Item [4]: The system according to item [3], wherein the policy type may include a plurality of policy types. A first policy subtype of the plurality of policy subtypes may be associated with a first policy type of the plurality of policy types. A second policy subtype of the plurality of policy subtypes may be associated with a second policy type of the plurality of policy types.
Item [5]: The system according to item [4], wherein the policy statement may include a plurality of policy objectives and a plurality of policy resources. Each of the plurality of policy subtypes has one of the plurality of policy objectives and one of the plurality of policy resources associated therewith. The policy condition may be associated with at least one of: the one of the plurality of policy objectives and the one of the plurality of policy resources.
Item [6]: The system according to one or more of items [1]-[5], wherein the policy condition may include at least one of: an event-based condition, a time-based condition, a counter-based condition, and a computed-expression-based condition.
Item [7]: The system according to one or more of items [1]-[6], wherein the policy type may include at least one of: a network energy-saving policy, a traffic steering policy, a quality of service (QoS) policy, a mobility management policy, a load balancing policy, a network slice management policy, a user equipment (UE) power-saving policy, an anomaly detection policy, a network fault management policy, and a security assurance policy.
Item [8]: The system according to one or more of items [1]-[7], wherein the policy type may include a plurality of policy types, the policy subtype may include a plurality of policy subtypes, the policy objective may include a plurality of policy objectives, and the policy resource may a plurality of policy resources. Each of the plurality policy subtypes may be associated with a respective one of the plurality of policy types. Each of the plurality of policy objectives and each of the plurality of policy resources may be associated with a respective one of the plurality of policy subtypes. The policy condition may be associated with at least one: at least one of the plurality of policy objectives and at least one of the plurality of policy resources.
Item [9]: The system according to item [8], wherein the policy condition may include a plurality of policy conditions. A first policy condition of the plurality of conditions may be associated with at least one of: a first policy objective of the policy objective and a first policy resource of the plurality of policy resources. A second policy condition of the plurality of conditions may be associated with at least one of: a second policy objective of the policy objective and a second policy resource of the plurality of policy resources.
Item [10]: A method including: generating, by a Non-RT RIC, an A1 policy executable by a Near-RT RIC, and providing, by the Non-RT RIC and via an A1 interface, the A1 policy to the Near-RT RIC. The A1 policy may include a scope identifier defining at least one node to which the policy can be applied and a policy statement defining the content of the A1 policy. The policy statement may include a policy type defining a type of the A1 policy, a policy subtype associated with the policy type, a policy objective defining an objective of the policy subtype, a policy resource defining a resource that can be utilized to achieve the policy objective, and a policy condition defining a condition under which the policy statement should be enforced. The policy condition may be associated with at least one of the policy objective and the policy resource.
Item [11]: The method according to item [10], wherein the policy condition may include a plurality of policy conditions. A first policy condition of the plurality of policy conditions may be associated with the policy objective. A second policy condition of the plurality of policy conditions may be associated with the policy resource.
Item [12]: The method according to one or more of items [10]-[11], wherein the policy subtype may include a plurality of policy subtypes. The plurality of policy subtypes may be associated with the policy type.
Item [13]: The method according to item [12], wherein the policy type may include a plurality of policy types. A first policy subtype of the plurality of policy subtypes may be associated with a first policy type of the plurality of policy types. A second policy subtype of the plurality of policy subtypes may be associated with a second policy type of the plurality of policy types.
Item [14]: The method according to item [13], wherein the policy statement may include a plurality of policy objectives and a plurality of policy resources. Each of the plurality of policy subtypes has one of the plurality of policy objectives and one of the plurality of policy resources associated therewith. The policy condition may be associated with at least one of: the one of the plurality of policy objectives and the one of the plurality of policy resources.
Item [15]: The method according to one or more of items [10]-[14], wherein the policy condition may include at least one of: an event-based condition, a time-based condition, a counter-based condition, and a computed-expression-based condition.
Item [16]: The method according to one or more of items [10]-[15], wherein the policy type may include at least one of: a network energy-saving policy, a traffic steering policy, a quality of service (QoS) policy, a mobility management policy, a load balancing policy, a network slice management policy, a user equipment (UE) power-saving policy, an anomaly detection policy, a network fault management policy, and a security assurance policy.
Item [17]: The method according to one or more of items [10]-[16], wherein the policy type may include a plurality of policy types, the policy subtype may include a plurality of policy subtypes, the policy objective may include a plurality of policy objectives, and the policy resource may a plurality of policy resources. Each of the plurality policy subtypes may be associated with a respective one of the plurality of policy types. Each of the plurality of policy objectives and each of the plurality of policy resources may be associated with a respective one of the plurality of policy subtypes. The policy condition may be associated with at least one: at least one of the plurality of policy objectives and at least one of the plurality of policy resources.
Item [18]: The method according to item [17], wherein the policy condition may include a plurality of policy conditions. A first policy condition of the plurality of conditions may be associated with at least one of: a first policy objective of the policy objective and a first policy resource of the plurality of policy resources. A second policy condition of the plurality of conditions may be associated with at least one of: a second policy objective of the policy objective and a second policy resource of the plurality of policy resources.
Item [19]: A non-transitory computer-readable recording medium having recorded thereon instructions executable by a system that includes a non-real-time (Non-RT) radio access network intelligent controller (RIC) to cause the Non-RT RIC to perform a method. The method may include: generating, by a Non-RT RIC, an A1 policy executable by a Near-RT RIC, and providing, by the Non-RT RIC and via an A1 interface, the A1 policy to the Near-RT RIC. The A1 policy may include a scope identifier defining at least one node to which the policy can be applied and a policy statement defining the content of the A1 policy. The policy statement may include a policy type defining a type of the A1 policy, a policy subtype associated with the policy type, a policy objective defining an objective of the policy subtype, a policy resource defining a resource that can be utilized to achieve the policy objective, and a policy condition defining a condition under which the policy statement should be enforced. The policy condition may be associated with at least one of the policy objective and the policy resource.
Item [20]: The non-transitory computer-readable recording medium according to item [19], wherein the policy condition may include a plurality of policy conditions. A first policy condition of the plurality of policy conditions may be associated with the policy objective. A second policy condition of the plurality of policy conditions may be associated with the policy resource.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A system comprising:
a non-real-time (Non-RT) radio access network intelligent controller (RIC) configured to:
generate an A1 policy executable by a near-real-time (Near-RT) RIC; and
provide, via an A1 interface, the A1 policy to the Near-RT RIC,
wherein the A1 policy comprises: a scope identifier defining at least one node to which the policy can be applied and a policy statement defining the content of the A1 policy,
wherein the policy statement comprises: a policy type defining a type of the A1 policy, a policy subtype associated with the policy type, a policy objective defining an objective of the policy subtype, a policy resource defining a resource that can be utilized to achieve the policy objective, and a policy condition defining a condition under which the policy statement should be enforced, and
wherein the policy condition is associated with at least one of the policy objective and the policy resource.

2. The system according to claim 1,
wherein the policy condition comprises a plurality of policy conditions,
wherein a first policy condition of the plurality of policy conditions is associated with the policy objective, and
wherein a second policy condition of the plurality of policy conditions is associated with the policy resource.

3. The system according to claim 1,
wherein the policy subtype comprises a plurality of policy subtypes, and
wherein the plurality of policy subtypes is associated with the policy type.

4. The system according to claim 3,
wherein the policy type comprises a plurality of policy types,
wherein a first policy subtype of the plurality of policy subtypes is associated with a first policy type of the plurality of policy types, and
wherein a second policy subtype of the plurality of policy subtypes is associated with a second policy type of the plurality of policy types.

5. The system according to claim 4,
wherein the policy statement comprises a plurality of policy objectives and a plurality of policy resources,
wherein each of the plurality of policy subtypes has one of the plurality of policy objectives and one of the plurality of policy resources associated therewith, and
wherein the policy condition is associated with at least one of: the one of the plurality of policy objectives and the one of the plurality of policy resources.

6. The system according to claim 1, wherein the policy condition comprises at least one of: an event-based condition, a time-based condition, a counter-based condition, and a computed-expression-based condition.

7. The system according to claim 1, wherein the policy type comprises at least one of: a network energy-saving policy, a traffic steering policy, a quality of service (QoS) policy, a mobility management policy, a load balancing policy, a network slice management policy, a user equipment (UE) power saving policy, an anomaly detection policy, a network fault management policy, and a security assurance policy.

8. The system according to claim 1,
wherein the policy type comprises a plurality of policy types, the policy subtype comprises a plurality of policy subtypes, the policy objective comprises a plurality of policy objectives, and the policy resource comprises a plurality of policy resources;
wherein each of the plurality policy subtypes is associated with a respective one of the plurality of policy types;
wherein each of the plurality of policy objectives and each of the plurality of policy resources is associated with a respective one of the plurality of policy subtypes; and
wherein the policy condition is associated with at least one: at least one of the plurality of policy objectives and at least one of the plurality of policy resources.

9. The system according to claim 8,
wherein the policy condition comprises a plurality of policy conditions,
wherein a first policy condition of the plurality of conditions is associated with at least one of: a first policy objective of the policy objective and a first policy resource of the plurality of policy resources, and
wherein a second policy condition of the plurality of conditions is associated with at least one of: a second policy objective of the policy objective and a second policy resource of the plurality of policy resources.

10. A method comprising:
generating, by a non-real-time (Non-RT) radio access network intelligent controller (RIC), an A1 policy executable by a near-real-time (Near-RT) RIC; and
providing, by the Non-RT RIC and via an A1 interface, the A1 policy to the Near-RT RIC,
wherein the A1 policy comprises: a scope identifier defining at least one node to which the policy can be applied and a policy statement defining the content of the A1 policy,
wherein the policy statement comprises: a policy type defining a type of the A1 policy, a policy subtype associated with the policy type, a policy objective defining an objective of the policy subtype, a policy resource defining a resource that can be utilized to achieve the policy objective, and a policy condition defining a condition under which the policy statement should be enforced, and
wherein the policy condition is associated with at least one of the policy objective and the policy resource.

11. The method according to claim 1
wherein the policy condition comprises a plurality of policy conditions,
wherein a first policy condition of the plurality of policy conditions is associated with the policy objective, and
wherein a second policy condition of the plurality of policy conditions is associated with the policy resource.

12. The method according to claim 10,
wherein the policy subtype comprises a plurality of policy subtypes, and
wherein the plurality of policy subtypes is associated with the policy type.

13. The method according to claim 12,
wherein the policy type comprises a plurality of policy types,
wherein a first policy subtype of the plurality of policy subtypes is associated with a first policy type of the plurality of policy types, and
wherein a second policy subtype of the plurality of policy subtypes is associated with a second policy type of the plurality of policy types.

14. The method according to claim 13,
wherein the policy statement comprises a plurality of policy objectives and a plurality of policy resources,
wherein each of the plurality of policy subtypes has one of the plurality of policy objectives and one of the plurality of policy resources associated therewith, and
wherein the policy condition is associated with at least one of: the one of the plurality of policy objectives and the one of the plurality of policy resources.

15. The method according to claim 10, wherein the policy condition comprises at least one of:
an event-based condition, a time-based condition, a counter-based condition, and a computed-expression-based condition.

16. The method according to claim 10, wherein the policy type comprises at least one of: a network energy-saving policy, a traffic steering policy, a quality of service (QOS) policy, a mobility management policy, a load balancing policy, a network slice management policy, a user equipment (UE) power saving policy, an anomaly detection policy, a network fault management policy, and a security assurance policy.

17. The method according to claim 10,
wherein the policy type comprises a plurality of policy types, the policy subtype comprises a plurality of policy subtypes, the policy objective comprises a plurality of policy objectives, and the policy resource comprises a plurality of policy resources;
wherein each of the plurality policy subtypes is associated with a respective one of the plurality of policy types;
wherein each of the plurality of policy objectives and each of the plurality of policy resources is associated with a respective one of the plurality of policy subtypes; and
wherein the policy condition is associated with at least one: at least one of the plurality of policy objectives and at least one of the plurality of policy resources

18. The method according to claim 17,
wherein the policy condition comprises a plurality of policy conditions, and
wherein a first policy condition of the plurality of conditions is associated with at least one of: a first policy objective of the policy objective and a first policy resource of the plurality of policy resources, and
wherein a second policy condition of the plurality of conditions is associated with at least one of: a second policy objective of the policy objective and a second policy resource of the plurality of policy resources

19. A non-transitory computer-readable recording medium having recorded thereon instructions executable by a system that includes a non-real-time (Non-RT) radio access network intelligent controller (RIC) to cause the Non-RT RIC to perform a method comprising:
generating, by a non-real-time (Non-RT) radio access network intelligent controller (RIC), an A1 policy executable by a near-real-time (Near-RT) RIC; and
providing, by the Non-RT RIC and via an A1 interface, the A1 policy to the Near-RT RIC,
wherein the A1 policy comprises: a scope identifier defining at least one node to which the policy can be applied and a policy statement defining the content of the A1 policy,
wherein the policy statement comprises: a policy type defining a type of the A1 policy, a policy subtype associated with the policy type, a policy objective defining an objective of the policy subtype, a policy resource defining a resource that can be utilized to achieve the policy objective, and a policy condition defining a condition under which the policy statement should be enforced, and
wherein the policy condition is associated with at least one of the policy objective and the policy resource.

20. The non-transitory computer-readable recording medium according to claim 19,
wherein the policy condition comprises a plurality of policy conditions,
wherein a first policy condition of the plurality of policy conditions is associated with the policy objective, and
wherein a second policy condition of the plurality of policy conditions is associated with the policy resource.
